(19) United States
(12) Patent Application Publication
(10) Pub. No.: US 2018/0270649 A1
(43) Pub. Date: Sep. 20, 2018

(54) Method For Improving Data Throughput In Multiple-SIM Communication Apparatus

(71) Applicant: MediaTek Inc., Hsinchu City (TW)

(72) Inventors: Chih-Yuan Tsai, Hsinchu City (TW); Chi-Chen Lee, Hsinchu City (US)

(21) Appl. No.: 15/912,482

(22) Filed: Mar. 5, 2018

Related U.S. Application Data
(60) Provisional application No. 62/473,578, filed on Mar. 20, 2017.

(51) Int. Cl. H04W 8/20; H04W 88/06; H04W 36/00

(52) U.S. Cl. CPC H04W 8/205; H04W 60/005; H04W 36/0027; H04W 88/06

(57) ABSTRACT

Various solutions for improving data throughput with respect to a multiple subscriber identity module (SIM) user equipment (UE) in mobile communications are described. The UE may perform data transmission associated with a first SIM. The UE may determine whether to suspend a recovery procedure associated with a second SIM according to a condition. The UE may suspend the recovery procedure associated with the second SIM in an event that the condition is satisfied. The UE may further resume the recovery procedure associated with the second SIM when the first SIM enters an idle mode.

### CROSS REFERENCE TO RELATED PATENT APPLICATION

The present disclosure is part of a non-provisional application claiming the priority benefit of U.S. Provisional Patent Application No. 62/473,578, filed on 20 Mar. 2017, the content of which is incorporated by reference in its entirety.

### TECHNICAL FIELD

The present disclosure is generally related to multiple subscriber identity module (SIM) communication apparatus and, more particularly, to data throughput improvement with respect to multiple SIM user equipment in mobile communications.

### BACKGROUND

Unless otherwise indicated herein, approaches described in this section are not prior art to the claims listed below and are not admitted as prior art by inclusion in this section.

There are various well-developed and well-defined cellular communications technologies in telecommunications that enable wireless communications using mobile terminals, or user equipment (UE). For example, the Global System for Mobile communications (GSM) is a well-defined and commonly used communications system, which uses time division multiple access (TDMA) technology, which is a multiplex access scheme for digital radio, to send voice, video, data, and signaling information (such as a dialed telephone number) between mobile phones and cell sites. The CDMA2000 is a hybrid mobile communications 2.5G/3G (generation) technology standard that uses code division multiple access (CDMA) technology. The UMTS (Universal Mobile Telecommunications System) is a 3G mobile communications system, which provides an enhanced range of multimedia services over the GSM system. The Long-Term Evolution (LTE), as well as its derivatives such as LTE-Advanced and LTE-Advanced Pro, is a standard for high-speed wireless communication for mobile phones and data terminals.

In a UE configured with dual SIM cards and single radio module, the UE is capable of camping on one of the above mentioned wireless communication networks for each SIM. The UE is also capable of performing data transfer for one SIM while keeping in normal service for the other SIM by cooperatively sharing the single radio module for the dual SIM cards. When the UE moves to certain areas without network signal coverage, a recovery procedure will be triggered for regaining the service from the wireless communication network. However, when performing the recovery procedure, the single radio module would be occupied for a certain time period and is not able to perform other activities during the recovery procedure. If one of the dual SIM card is performing data transfer or needs to perform data transfer, it would be interrupted by the recovery procedure triggered by the other SIM. The recovery procedure for one SIM in no service areas may impact data throughput of the other SIM and may waste network resources.

Accordingly, when a dual SIM UE moves to certain areas without service coverage, it is not clear how and when to perform the recovery procedure. There is vulnerability in implementation regarding how to regain service for one SIM without decreasing data throughput for the other SIM. The uncertainty may lead to performance degradation and worse user experiences.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues with respect to data throughput improvement and recovery procedures on a UE. In implementations in accordance with the present disclosure, when a multiple SIM UE moves to certain areas without service coverage for one SIM, the UE has to determine how to perform the recovery procedures without degrading the data throughput for the other SIMs.

In one example implementation, a method may involve a communication apparatus configured with a first SIM and a second SIM performing data transmission associated with the first SIM. The method may also involve the communication apparatus determining whether to suspend a recovery procedure associated with the second SIM according to a condition. The method may further involve the communication apparatus suspending the recovery procedure associated with the second SIM in an event that the condition is satisfied.

In another example implementation, a communication apparatus may comprise a first SIM and a second SIM. The communication apparatus may also comprise a transceiver capable of performing data transmission associated with the first SIM and the second SIM. The communication apparatus may further comprise a processor capable of determining whether to suspend a recovery procedure associated with the second SIM according to a condition when the transceiver is performing data transmission associated with the first SIM and suspending the recovery procedure associated with the second SIM in an event that the condition is satisfied.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example PLMN table under schemes in accordance with implementations of the present disclosure.

FIG. 3 is a block diagram of an example communication apparatus in accordance with an implementation of the present disclosure.

FIG. 4 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to data throughput improvement with respect to multiple SIM user equipment in mobile communications. According to the present disclosure, a number of possible solutions may be implemented separately or jointly. That is, although these possible solutions may be described below separately, two or more of these possible solutions may be implemented in one combination or another.

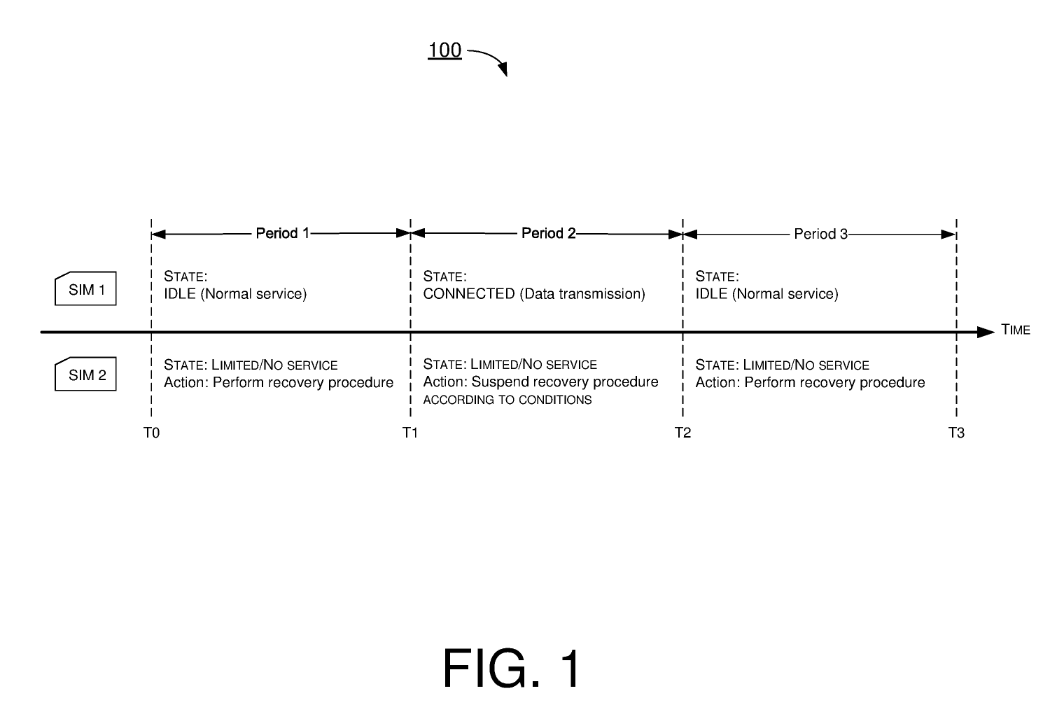

FIG. 1 illustrates an example scenario 100 under schemes in accordance with implementations of the present disclosure. Scenario 100 involves a user equipment (UE) and a plurality of cells (e.g., base stations, network nodes or eNodeBs). The plurality of cells may be part of a wireless network such as, for example and without limitation, a 2G/2.5G network (e.g., a Global System for Mobile communications (GSM) network, a General Packet Radio Service (GPRS) network or an Enhanced Data rates for GSM Evolution (EDGE) network), a 3G/3.5G network (e.g., a Universal Mobile Telecommunications System (UMTS) network, a Time Division-Synchronous Code Division Multiple Access (TD-SCDMA) network, a CDMA2000 network or a High Speed Downlink Packet Access (HSDPA) network), a 4G network (e.g., a LTE network, a LTE-Advanced network or a LTE-Advanced Pro network), or a 5G network.

The UE is configured with a first subscriber identity module (SIM) card and a second SIM card. The UE may comprise a radio frequency transceiver which is cooperatively shared by the first SIM and the second SIM. This means that the radio frequency transceiver can only be used by one of the first SIM and the second SIM at one time instant. In operation, the first SIM may camp on a first cell associated with a first wireless network and the second SIM may camp on a second cell associated with a second wireless network. When the UE moves to certain areas, a SIM may temporarily lose services from the cells and be in a state of limited service or no service. In the state of limited service, the wireless network is unable to provide normal service and may only provide emergency bearer services. The UE is unable to initiate a mobile originated (MO) call, receive a mobile terminated (MT) call or perform data transmission in the state of limited service or no service. When a SIM enters the state of limited service or no service, the UE will perform a recovery procedure and try to regain normal service from the cells. In the recovery procedure, the UE may perform a frequency scan or a full-band scan to search for a suitable cell for camping on. It may occupy a certain time period of the radio frequency transceiver and consume significant power of the UE for performing the recovery procedure.

As showed in FIG. 1, in period 1 (i.e., time t0 to time t1), SIM 1 is in a state of idle mode and SIM 2 is in a state of limited service or no service mode. In the idle mode, the UE is in a power saving state and does not perform data transmission. In period 1, the UE is able to perform a recovery procedure associated with SIM 2 for regaining normal service from the second wireless network. Since SIM 1 is in the idle mode, the recovery procedure associated with SIM 2 will not affect the data throughput associated with SIM 1.

In period 2 (i.e., time t1 to time t2), SIM 1 is in a state of connected mode and SIM 2 is still in a state of limited service or no service mode. In the connected mode, the UE is performing data transmission associated with SIM 1. Since SIM 2 is still in the state of limited service or no service, the UE may still need to perform a recovery procedure associated with SIM 2 for regaining normal service from the second wireless network. However, while the radio frequency transceiver is used by SIM 1 for data transmission, if the UE performs the recovery procedure associated with SIM 2, the data transmission associated with SIM 1 will be interrupted. The data throughput and latency associated with SIM 1 will be affected by SIM 2. Accordingly, the present disclosure proposes multiple solutions to prevent or reduce data throughput degradation of SIM 1. Specifically, as showed in FIG. 1, while the UE is performing data transmission associated with SIM 1 and SIM 2 is in the state of limited service or no service, the UE will determine whether to suspend a recovery procedure associated with SIM 2 according to at least one of conditions. in an event that the at least one of conditions is satisfied, the UE will determine to suspend the recovery procedure associated with SIM 2 to avoid data throughput degradation of SIM 1.

In period 3 (i.e., time t2 to time t3), the data transmission associated with SIM is finished and SIM 1 enters a state of idle mode. SIM 2 is still in a state of limited service or no service mode. When SIM 1 enters the state of idle mode and does not perform data transmission, the UE is able to resume the recovery procedure associated with SIM 2. Since SIM 1 is in the idle mode, the recovery procedure associated with SIM 2 will not affect the data throughput associated with SIM 1.

The present disclosure proposes a plurality of conditions with respect to how the UE determines to suspend a recovery procedure of one SIM to avoid data throughput degradation of another SIM. The details of the plurality of conditions will be described in the following paragraphs.

In some implementations, the conditions may comprise a user preference and the UE may suspend the recovery procedure associated with SIM 2 according to the user preference. For example, the UE may provide a user interface for a user to enable a data preferred mode. In the data preferred mode, data transmission has a higher priority and should not be interrupted by other procedures. in an event that the data preferred mode is enabled, the UE should stop or suspend activities of other SIMs when data transmission is performed for one SIM. Therefore, the UE will determine to suspend the recovery procedure associated with SIM 2 when the UE is performing data transmission associated with SIM 1. In another example, a user may configure a certain SIM to have a higher priority. The UE is configured to perform the activities for the high priority SIM first and suspend the activities for the other SIMs. Therefore, in an event that SIM 1 have a higher priority than SIM 2, the UE will determine to suspend the recovery procedure associated with SIM 2 when SIM 1 is in data transmission. Accordingly, in an event that a condition indicates that the UE is in a data preferred mode or SIM 1 has a high priority, the UE may determine to skip and not to perform the recovery procedure associated with SIM 2 to avoid interrupting the data transmission of SIM 1.

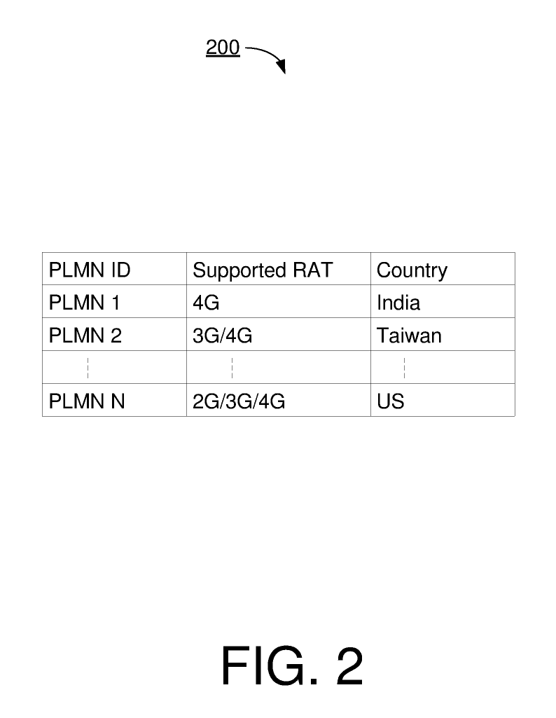

In some implementations, the conditions may indicate a non-supported RAT and the UE may suspend the recovery procedure associated with SIM 2 for the non-supported RAT. Specifically, the conditions may comprise a public land mobile network (PLMN) table. The PLMN table may record a plurality of PLMN identities (IDs) and the supported or non-supported radio access technology (RAT) in certain country of each PLMN ID. For example, as showed in FIG. 2, PLMN table 200 comprised a plurality of PLMN IDs such as PLMN 1, PLMN 2 . . . and PLMN N. Each PLMN ID has a corresponding serving country and the supported RAT. PLMN 1 is in India and only supports a 4G network. PLMN 2 is in Taiwan and can support both a 3G network and a 4G network. PLMN N is in US and can support a 2G network, a 3G network and a 4G network. Normally, in an event that a UE has the capability for supporting multiple RATs communication, the UE will scan the frequency band in each RAT for searching for a suitable cell. However, in an event that a RAT is not supported by a SIM, the frequency scan for the non-supported RAT would be inefficient and may waste radio resources.

In view of the PLMN table, the UE may determine whether to suspend a recovery procedure associated with a SIM for the non-supported RAT according to the PLMN table. Specifically, in an event that SIM 2 of the UE is configured as PLMN 1, the UE can determine that 2G and 3G networks are the non-supported RAT of SIM 2 according to PLMN table 200. When the UE moves to a certain area without service coverage of the second wireless network (i.e., SIM 2 is in the state of limited service or no service), the UE will determine to suspend the recovery procedure associated with SIM 2 for 2G and 3G networks. Since 2G and 3G networks are not supported by SIM 2, it is not possible for the UE to regain the service from the second wireless network by performing the recovery procedure for 2G and 3G networks. Accordingly, in an event that a RAT is indicated as a non-supported RAT, the UE may determine to skip and not to perform the recovery procedure for the RAT to avoid interrupting the data transmission of SIM 1. Similarly, in an event that SIM 2 of the UE is configured as PLMN 2 which only support 3G and 4G networks, the UE will determine to suspend the recovery procedure associated with SIM 2 for 2G network. Accordingly, in an event that a condition indicates that a RAT is a non-supported RAT of SIM 2, the UE may determine to skip and not to perform the recovery procedure associated with SIM 2 for the non-supported RAT to avoid interrupting the data transmission of SIM 1.

In some implementations, the conditions may indicate a PLMN list and the UE may suspend the recovery procedure associated with SIM 2 for the PLMN list. Specifically, the conditions may comprise a roaming history of SIM 2. The UE may perform roaming and try to register among a plurality of PLMNs before for SIM 2. The UE may maintain a PLMN list recording the PLMNs which the UE failed to register on. When the UE is performing data transmission associated with SIM 1 and SIM 2 is in a roaming state, the UE may determine to suspend the recovery procedure associated with SIM 2 for the PLMNs in the PLMN list. Since the UE failed to register on the PLMNs in the PLMN list before, the UE may have high possibility to be rejected again by those PLMNs. Accordingly, in an event that a condition indicates that a PLMN is in a specific PLMN list, the UE may determine to skip and not to perform the recovery procedure associated with SIM 2 for the PLMN to avoid interrupting the data transmission of SIM 1.

In some implementations, the condition may indicate whether SIM 2 can perform data transmission via another SIM and the UE may suspend the recovery procedure associated with SIM 2 in an event that SIM 2 can perform data transmission via another SIM. Specifically, SIM 2 may be configured to be able to transmit or receive data packets via SIM 1 and the first wireless network. When SIM 1 established one or more radio bearers with the first wireless network, SIM 2 may set up an Internet Protocol Security (IPsec) tunnel with an evolved Packet Data Gateway (ePDG) of the second wireless network via the radio bearers of SIM 1. SIM 2 is able to register an IP Multimedia Subsystem (IMS) service with the second wireless network via the IPsec tunnel and perform data transmission via the radio bearers of SIM 1. Since SIM 2 can perform data transmission via SIM 1, SIM 2 may not be in the state of limited service or no service and the UE may not need to perform the recovery procedure for SIM 2. Accordingly, in an event that a condition indicates that SIM 2 can perform data transmission via another SIM, the UE may determine to skip and not to perform the recovery procedure associated with SIM 2 to avoid interrupting the data transmission of SIM 1.

In some implementations, the condition may indicate whether SIM 2 can perform data transmission via another service network and the UE may suspend the recovery procedure associated with SIM 2 in an event that SIM 2 can perform data transmission via another service network. Specifically, SIM 2 may be configured to be able to transmit or receive data packets via another service network such as, for example and without limitation, a WiFi network. When the UE established one or more radio bearers with the WiFi network, SIM 2 may be able to accesses the ePDG of the second wireless network via the WiFi radio bearers and register an IMS service with the second wireless network through the ePDG. Since SIM 2 can perform data transmission via the WiFi network, SIM 2 may not be in the state of limited service or no service and the UE may not need to perform the recovery procedure for SIM 2. Accordingly, in an event that a condition indicates that SIM 2 can perform data transmission via another service network, the UE may determine to skip and not to perform the recovery procedure associated with SIM 2 to avoid interrupting the data transmission of SIM 1.

In some implementations, the condition may indicate a state of SIM 1 and the UE may suspend the recovery procedure associated with SIM 2 when the state of SIM 1 enters a connected mode. Specifically, the UE may just monitor the state of SIM 1. in an event that the state of SIM 1 is in a connected mode or is transited from an idle mode to a connected mode, it means that the UE may perform data transmission for SIM 1 during the connected mode. The UE may simply suspend the recovery procedure for SIM 2 during the connected mode of SIM 1 to avoid possible interruption of the data transmission of SIM 1. Accordingly, in an event that a condition indicates that SIM 1 is in a connected mode, the UE may determine to skip and not to perform the recovery procedure associated with SIM 2 to avoid interrupting the data transmission of SIM 1.

In some implementations, when the UE determines to suspend the recovery procedure associated with SIM 2 according to the above-mentioned conditions, the UE may suspend the recovery procedure during the whole data transmission period of SIM 1. Alternatively, the UE may suspend the recovery procedure for parts of the data transmission period of SIM 1. In other words, the UE may reduce the frequency of data transmission interruptions of SIM 1 caused by the recovery procedure associated with SIM 2. For example, in an event that SIM 2 is configured as PLMN 1 which only support a 4G network and is in the state of limited service or no service, when the UE is performing data transmission associated with SIM 1, the UE may determine to suspend the recovery procedure associated with SIM 2 for 2G and 3G networks. However, the UE may still need to perform the recovery procedure associated with SIM 2 for the 4G network to regain service from the second wireless network. In such scenario, the UE may reduce the frequency of performing the recovery procedure associated with SIM 2 to avoid serious data transmission degradation of SIM 1 and use only parts or few of time periods to perform the recovery procedure associated with SIM 2 for the 4G network. Since only parts or few of time periods are used to perform the recovery procedure associated with SIM 2, the throughput of data transmission of SIM 1 will not be affected seriously. Accordingly, by suspending parts of the recovery procedure associated with SIM 2, the UE may still have chances to regain normal service for SIM 2 without degrading the throughput of data transmission of SIM 1.

In some implementations, the UE may be configured with a plurality of SIMs (e.g., more than two SIMs). The plurality of SIMs can be physical SIM cards, virtual SIMs or the combinations thereof. Each SIM may register on a corresponding service network. The UE may also comprise more than one transceivers. While at least one of transceivers is cooperatively shared by more than one SIMs, the UE has to handle the resource conflict problems among the SIMs and data throughput degradation issues as raised in the present disclosure. Accordingly, the one or more solutions proposed in the present disclosure may also be used in the UE with multiple SIMs and multiple transceivers with or without modifications. The aforementioned scenarios are used to illustrate the concepts of the present inventions and are not intended to limit the scope of the present disclosure.

### Illustrative Implementations

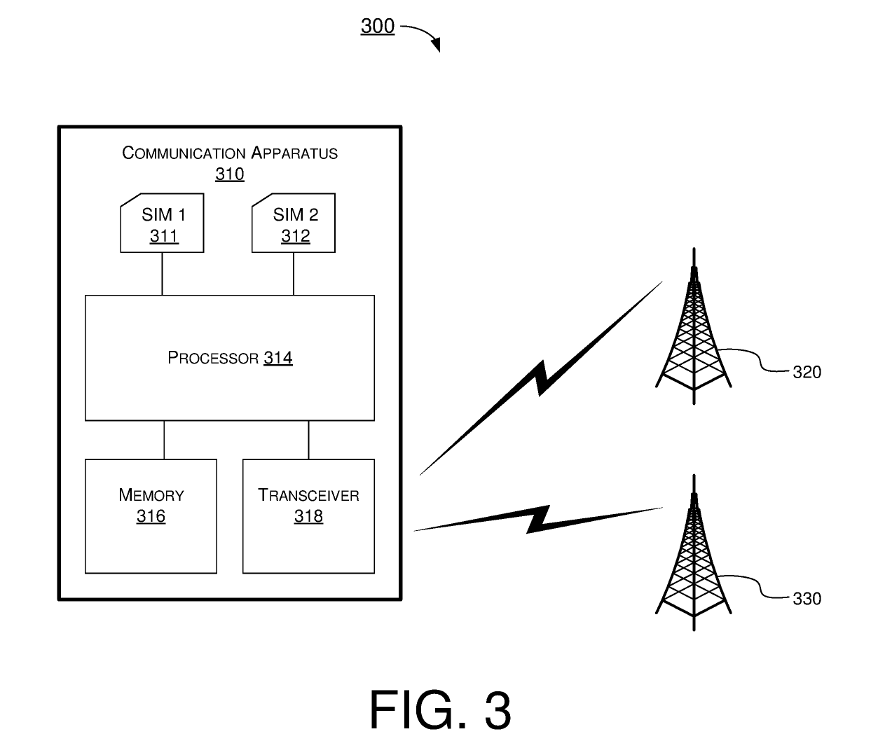

FIG. 3 illustrates an example communication apparatus 310 in accordance with an implementation of the present disclosure. Communication apparatus 310 may perform various functions to implement techniques, schemes, methods and solutions described herein. For instance, communication apparatus 310 may perform the multiple solutions and schemes 100 described above as well as processes 400 described below, whether individually or in any combination. In some implementations, communication apparatus 310 may be an electronic apparatus which may be a UE such as, for example, a smartphone, a mobile phone or any type of portable communications apparatus. In some implementations, communication apparatus 310 may be in the form of one or more integrated-circuit (IC) chip(s). Communication apparatus 310 may include one or more of those components shown in FIG. 3, such as a SIM 1 311, a SIM 2 312, a processor 314, a memory 316 and a transceiver 318. Communication apparatus 310 may include other component(s) not shown in FIG. 3 which may not be pertinent to the schemes, solutions, techniques and methods in accordance with the present disclosure and, thus, a description thereof is not provided. Processor 314 may be communicatively or otherwise operably coupled to SIM 1 311, SIM 2 312, memory 316 and transceiver 318. In some implementations, some or all of processor 314, memory 316 and transceiver 318 may be integral parts of a single IC chip. Alternatively, processor 314, memory 316 and transceiver 318 may be packaged as two or more separate and discrete IC chips.

Memory 316 may be configured to store data as well as one or more sets of processor-executable instructions. Memory 316 may include one or more computer-readable mediums such as a type of read-only memory (ROM) or random-access memory (RAM). For example, memory 316 may include a dynamic RAM (DRAM), static RAM (SRAM), thyristor RAM (T-RAM), zero-capacitor RAM (Z-RAM) or another type of volatile memory. As another example, memory device may include mask ROM, programmable ROM (PROM), erasable programmable ROM (EPROM), electrically-erasable programmable ROM (EEPROM), flash memory, solid-state memory or another type of non-volatile memory.

Transceiver 318 may include necessary hardware and/or software to perform wireless communications (e.g., transmit and receive wireless signals) with one or more external or remote devices such as, for example and not limited to, one or more cells, base stations or eNodeB stations. For instance, under the control of processor 314, transceiver 318 may engage in wireless communications with one or more eNodeB stations to transmit requests and receive messages.

Processor 314 may be implemented in the form of a single IC chip or a chipset of multiple IC chips. In one aspect, processor 314 may be implemented in the form of one or more single-core processors, one or more multi-core processors, or one or more CISC processors. That is, even though a singular term “a processor” is used herein to refer to processor 314, processor 314 may include multiple processors in some implementations and a single processor in other implementations in accordance with the present disclosure. In another aspect, processor 314 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 314 is a special-purpose machine specifically designed, arranged and configured to perform specific tasks including data throughput improvement between an apparatus and a network in accordance with various implementations of the present disclosure.

In some implementations, processor 314 is configured to camp on a first cell 320 for SIM 1 311 via the transceiver 318 and camp on a second cell 330 for SIM 2 312 via the transceiver 318. First cell 320 is associated with a first wireless network and second cell 330 is associated with a second wireless network. The first wireless network and the second wireless network may respectively be part of a service network such as, for example and without limitation, a 2G/2.5G network (e.g., a Global System for Mobile communications (GSM) network, a General Packet Radio Service (GPRS) network or an Enhanced Data rates for GSM Evolution (EDGE) network), a 3G/3.5G network (e.g., a Universal Mobile Telecommunications System (UMTS) network, a Time Division-Synchronous Code Division Multiple Access (TD-SCDMA) network, a CDMA2000 network or a High Speed Downlink Packet Access (HSDPA) network), a 4G network (e.g., a LTE network, a LTE-Advanced network or a LTE-Advanced Pro network), or a 5G network.

Transceiver 318 is cooperatively shared by SIM 1 311 and SIM 2 312. This means that transceiver 318 can only be used by one of SIM 1 311 and SIM 2 312 at one time instant. When communication apparatus 310 moves to certain areas, a SIM may temporarily lose services from the cells and be in a state of limited service or no service. In the state of limited service, the wireless network is unable to provide normal service and may only provide emergency bearer services. Processor 314 is unable to initiate a mobile originated (MO) call, receive a mobile terminated (MT) call or perform data transmission in the state of limited service or no service. When a SIM enters the state of limited service or no service, processor 314 will perform a recovery procedure and try to regain normal service from the cells. In the recovery procedure, processor 314 may perform a frequency scan or a full-band scan to search for a suitable cell for camping on. It may occupy a certain time period of transceiver 318 and consume significant power of communication apparatus 310 for performing the recovery procedure.

When SIM 1 311 is in a state of idle mode and SIM 2 312 is in a state of limited service or no service mode, processor 314 does not need to perform data transmission for SIM 1 311 and is able to perform a recovery procedure associated with SIM 2 for regaining normal service from the second wireless network. Since SIM 1 311 is in the idle mode, the recovery procedure associated with SIM 2 312 will not affect the data throughput associated with SIM 1 311.

When SIM 1 311 is in a state of connected mode and SIM 2 312 is still in a state of limited service or no service mode, processor 314 needs to perform data transmission associated with SIM 1 311. Since SIM 2 312 is still in the state of limited service or no service, processor 314 may also need to perform a recovery procedure associated with SIM 2 312 for regaining normal service from the second wireless network. However, while transceiver 318 is used by SIM 1 for data transmission, in an event that processor 314 performs the recovery procedure associated with SIM 2 312, the data transmission associated with SIM 1 311 will be interrupted. The data throughput and latency associated with SIM 1 311 will be affected by SIM 2 312. Accordingly, the present disclosure proposes multiple solutions to prevent or reduce data throughput degradation of SIM 1 311. Specifically, while processor 314 is performing data transmission associated with SIM 1 311 and SIM 2 312 is in the state of limited service or no service, processor 314 determine whether to suspend a recovery procedure associated with SIM 2 312 according to at least one of conditions. in an event that the at least one of conditions is satisfied, processor 314 will determine to suspend the recovery procedure associated with SIM 2 312 to avoid data throughput degradation of SIM 1 311.

The present disclosure proposes a plurality of conditions with respect to how processor 314 determines to suspend a recovery procedure of one SIM to avoid data throughput degradation of another SIM. The details of the plurality of conditions will be described in the following paragraphs.

In some implementations, the conditions may comprise a user preference and processor 314 may suspend the recovery procedure associated with SIM 2 312 according to the user preference. For example, processor 314 may provide a user interface for a user to enable a data preferred mode. In the data preferred mode, data transmission has a higher priority and should not be interrupted by other procedures. in an event that the data preferred mode is enabled, processor 314 should stop or suspend activities of other SIMs when data transmission is performed for one SIM. Therefore, processor 314 will determine to suspend the recovery procedure associated with SIM 2 312 when processor 314 is performing data transmission associated with SIM 1 311. In another example, a user may configure a certain SIM to have a higher priority. Processor 314 is configured to perform the activities for the high priority SIM first and suspend the activities for the other SIMs. Therefore, in an event that SIM 1 311 have a higher priority than SIM 2 312, processor 314 will determine to suspend the recovery procedure associated with SIM 2 312 when SIM 1 311 is in data transmission. Accordingly, in an event that a condition indicates that communication apparatus 310 is in a data preferred mode or SIM 1 311 has a high priority, processor 314 may determine to skip and not to perform the recovery procedure associated with SIM 2 312 to avoid interrupting the data transmission of SIM 1 311.

In some implementations, the conditions may indicate a non-supported RAT and processor 314 may suspend the recovery procedure associated with SIM 2 312 for the non-supported RAT. Specifically, the conditions may comprise a public land mobile network (PLMN) table stored in memory 316. The PLMN table may record a plurality of PLMN identities (IDs) and the supported or non-supported radio access technology (RAT) in certain country of each PLMN ID. For example, a PLMN table may comprise a plurality of PLMN IDs such as PLMN 1, PLMN 2 . . . and PLMN N. Each PLMN ID has a corresponding serving country and the supported RAT. PLMN 1 is in India and only supports a 4G network. PLMN 2 is in Taiwan and can support both a 3G network and a 4G network. PLMN N is in US and can support a 2G network, a 3G network and a 4G network. Normally, in an event that a communication apparatus has the capability for supporting multiple RATs communication, the processor will scan the frequency band in each RAT for searching for a suitable cell. However, in an event that a RAT is not supported by a SIM, the frequency scan for the non-supported RAT would be inefficient and may waste radio resources.

In view of the PLMN table, processor 314 may determine whether to suspend a recovery procedure associated with a SIM for the non-supported RAT according to the PLMN table. Specifically, in an event that SIM 2 312 is configured as PLMN 1, processor 314 can determine that 2G and 3G networks are the non-supported RAT of SIM 2 312 according to the PLMN table. When communication apparatus 310 moves to a certain area without service coverage of the second wireless network (i.e., SIM 2 312 is in the state of limited service or no service), processor 314 will determine to suspend the recovery procedure associated with SIM 2 312 for 2G and 3G networks. Since 2G and 3G networks are not supported by SIM 2 312, it is not possible to regain the service from the second wireless network by performing the recovery procedure for 2G and 3G networks. Accordingly, in an event that a RAT is indicated as a non-supported RAT, processor 314 may determine to skip and not to perform the recovery procedure for the RAT to avoid interrupting the data transmission of SIM 1 311. Similarly, in an event that SIM 2 312 is configured as PLMN 2 which only support 3G and 4G networks, processor 314 will determine to suspend the recovery procedure associated with SIM 2 312 for 2G network. Accordingly, in an event that a condition indicates that a RAT is a non-supported RAT of SIM 2 312, processor 314 may determine to skip and not to perform the recovery procedure associated with SIM 2 312 for the non-supported RAT to avoid interrupting the data transmission of SIM 1 311.

In some implementations, the conditions may indicate a PLMN list and processor 314 may suspend the recovery procedure associated with SIM 2 312 for the PLMN list. Specifically, the conditions may comprise a roaming history of SIM 2 312. Processor 314 may perform roaming and try to register among a plurality of PLMNs before for SIM 2 312. Processor 314 may maintain a PLMN list in memory 316 recording the PLMNs which processor 314 failed to register on. When processor 314 is performing data transmission associated with SIM 1 311 and SIM 2 312 is in a roaming state, processor 314 may determine to suspend the recovery procedure associated with SIM 2 312 for the PLMNs in the PLMN list. Since processor 314 failed to register on the PLMNs in the PLMN list before, it may have high possibility to be rejected again by those PLMNs. Accordingly, in an event that a condition indicates that a PLMN is in a specific PLMN list, processor 314 may determine to skip and not to perform the recovery procedure associated with SIM 2 312 for the PLMN to avoid interrupting the data transmission of SIM 1 311.

In some implementations, the condition may indicate whether SIM 2 312 can perform data transmission via another SIM and processor 314 may suspend the recovery procedure associated with SIM 2 312 in an event that SIM 2 312 can perform data transmission via another SIM. Specifically, SIM 2 312 may be configured to be able to transmit or receive data packets via SIM 1 311 and the first wireless network. When SIM 1 311 established one or more radio bearers with the first wireless network, SIM 2 312 may set up an Internet Protocol Security (IPsec) tunnel with an evolved Packet Data Gateway (ePDG) of the second wireless network via the radio bearers of SIM 1 311. SIM 2 312 is able to register an IP Multimedia Subsystem (IMS) service with the second wireless network via the IPsec tunnel and perform data transmission via the radio bearers of SIM 1 311. Since SIM 2 312 can perform data transmission via SIM 1 311, SIM 2 312 may not be in the state of limited service or no service and processor 314 may not need to perform the recovery procedure for SIM 2 312. Accordingly, in an event that a condition indicates that SIM 2 312 can perform data transmission via another SIM, processor 314 may determine to skip and not to perform the recovery procedure associated with SIM 2 312 to avoid interrupting the data transmission of SIM 1 311.

In some implementations, the condition may indicate whether SIM 2 312 can perform data transmission via another service network and processor 314 may suspend the recovery procedure associated with SIM 2 312 in an event that SIM 2 312 can perform data transmission via another service network. Specifically, SIM 2 312 may be configured to be able to transmit or receive data packets via another service network such as, for example and without limitation, a WiFi network. When processor 314 established one or more radio bearers with the WiFi network, SIM 2 312 may be able to accesses the ePDG of the second wireless network via the WiFi radio bearers and register an IMS service with the second wireless network through the ePDG. Since SIM 2 312 can perform data transmission via the WiFi network, SIM 2 312 may not be in the state of limited service or no service and processor 314 may not need to perform the recovery procedure for SIM 2 312. Accordingly, in an event that a condition indicates that SIM 2 312 can perform data transmission via another service network, processor 314 may determine to skip and not to perform the recovery procedure associated with SIM 2 312 to avoid interrupting the data transmission of SIM 1 311.

In some implementations, the condition may indicate a state of SIM 1 311 and processor 314 may suspend the recovery procedure associated with SIM 2 312 when the state of the SIM 1 311 enters a connected mode. Specifically, processor 314 may just monitor the state of SIM 1 311. in an event that the state of SIM 1 311 is in a connected mode or is transited from an idle mode to a connected mode, it means that processor 314 may perform data transmission for SIM 1 311 during the connected mode. Processor 314 may simply suspend the recovery procedure for SIM 2 312 during the connected mode of SIM 1 311 to avoid possible interruption of the data transmission of SIM 1 311. Accordingly, in an event that a condition indicates that SIM 1 311 is in a connected mode, processor 314 may determine to skip and not to perform the recovery procedure associated with SIM 2 312 to avoid interrupting the data transmission of SIM 1 311.

In some implementations, when processor 314 determines to suspend the recovery procedure associated with SIM 2 312 according to the above-mentioned conditions, processor 314 may suspend the recovery procedure during the whole data transmission period of SIM 1 311. Alternatively, processor 314 may suspend the recovery procedure for parts of the data transmission period of SIM 1 311. In other words, processor 314 may reduce the frequency of data transmission interruptions of SIM 1 311 caused by the recovery procedure associated with SIM 2 312. For example, in an event that SIM 2 312 is configured as PLMN 1 which only support a 4G network and is in the state of limited service or no service, when processor 314 is performing data transmission associated with SIM 1 311, processor 314 may determine to suspend the recovery procedure associated with SIM 2 312 for 2G and 3G networks. However, processor 314 may still need to perform the recovery procedure associated with SIM 2 312 for the 4G network to regain service from the second wireless network. In such scenario, processor 314 may reduce the frequency of performing the recovery procedure associated with SIM 2 312 to avoid serious data transmission degradation of SIM 1 311 and use only parts or few of time periods to perform the recovery procedure associated with SIM 2 312 for the 4G network. Since only parts or few of time periods are used to perform the recovery procedure associated with SIM 2 312, the throughput of data transmission of SIM 1 311 will not be affected seriously. Accordingly, by suspending parts of the recovery procedure associated with SIM 2 312, processor 314 may still have chances to regain normal service for SIM 2 312 without degrading the throughput of data transmission of SIM 1 311.

In some implementations, the communication apparatus may be configured with a plurality of SIMs (e.g., more than two SIMs). The plurality of SIMs can be physical SIM cards, virtual SI Ms or the combinations thereof. Each SIM may register on a corresponding service network. The communication apparatus may also comprise more than one transceivers. While at least one of transceivers is cooperatively shared by more than one SIMs, the communication apparatus has to handle the resource conflict problems among the SIMs and data throughput degradation issues as raised in the present disclosure. Accordingly, the one or more solutions proposed in the present disclosure may also be used in the communication apparatus with multiple SIMs and multiple transceivers with or without modifications. The aforementioned scenarios are used to illustrate the concepts of the present inventions and are not intended to limit the scope of the present disclosure.

### Illustrative Processes

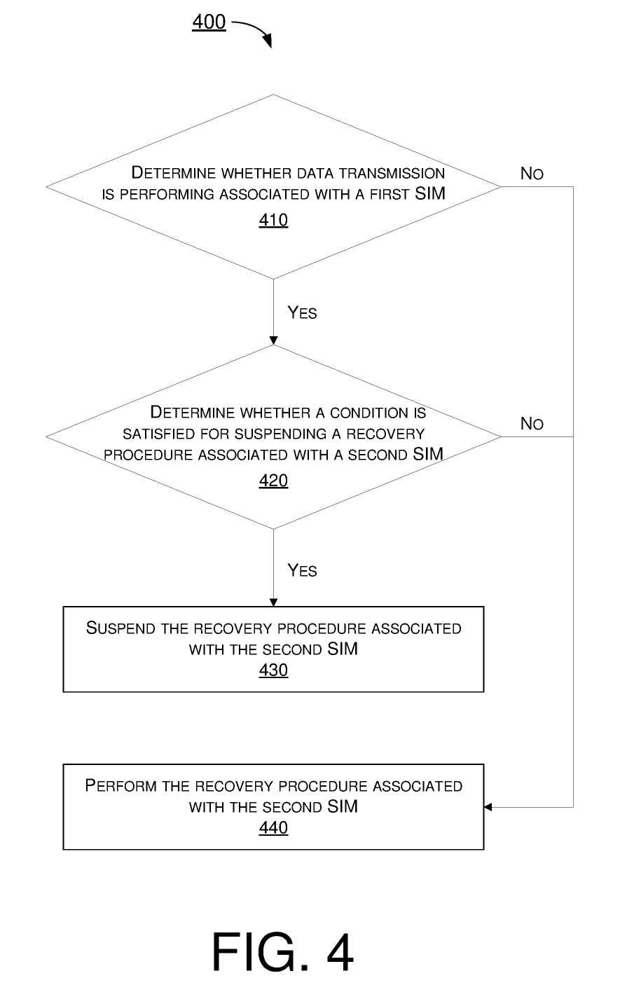

FIG. 4 illustrates an example process 400 in accordance with an implementation of the present disclosure. Process 400 may be an example implementation of scenario 100, whether partially or completely, with respect to data throughput improvement in accordance with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310 configured with a first SIM and a second SIM. Process 400 may begin at block 410.

At 410, process 400 may involve communication apparatus 310 determining whether data transmission is performed associated with a first SIM. If no, process 400 may proceed from 410 to 440. If yes, process 400 may proceed from 410 to 420.

At 420, process 400 may involve communication apparatus 310 determining whether a condition is satisfied for suspending a recovery procedure associated with a second SIM. If no, process 400 may proceed from 420 to 440. If yes, process 400 may proceed from 420 to 430.

At 430, process 400 may involve communication apparatus 310 suspending the recovery procedure associated with the second SIM.

At 440, process 400 may involve communication apparatus 310 performing the recovery procedure associated with the second SIM.

In some implementations, communication apparatus 310 is configured to camp on a first cell for the first SIM and camp on a second cell for the second SIM. The first cell is associated with a first wireless network and the second cell is associated with a second wireless network. The first wireless network and the second wireless network may respectively be part of a service network such as, for example and without limitation, a 2G/2.5G network (e.g., a Global System for Mobile communications (GSM) network, a General Packet Radio Service (GPRS) network or an Enhanced Data rates for GSM Evolution (EDGE) network), a 3G/3.5G network (e.g., a Universal Mobile Telecommunications System (UMTS) network, a Time Division-Synchronous Code Division Multiple Access (TD-SCDMA) network, a CDMA2000 network or a High Speed Downlink Packet Access (HSDPA) network), a 4G network (e.g., a LTE network, a LTE-Advanced network or a LTE-Advanced Pro network), or a 5G network.

In some implementations, the condition may comprise a user preference and process 400 may involve communication apparatus 310 suspending the recovery procedure associated with the second SIM according to the user preference. in an event that a condition indicates that communication apparatus 310 is in a data preferred mode or the first SIM has a high priority, process 400 may involve communication apparatus 310 skipping and not performing the recovery procedure associated with the second SIM to avoid interrupting the data transmission of the first SIM.

In some implementations, the conditions may indicate a non-supported RAT and process 400 may involve communication apparatus 310 suspending the recovery procedure associated with the second SIM for the non-supported RAT. Specifically, the conditions may comprise a public land mobile network (PLMN) table. The PLMN table may record a plurality of PLMN identities (IDs) and the supported or non-supported radio access technology (RAT) in certain country of each PLMN ID. In view of the PLMN table, communication apparatus 310 may determine whether to suspend a recovery procedure associated with the second SIM for the non-supported RAT according to the PLMN table. in an event that a condition indicates that a RAT is a non-supported RAT of the second SIM, process 400 may involve communication apparatus 310 skipping and not performing the recovery procedure associated with the second SIM for the non-supported RAT to avoid interrupting the data transmission of the first SIM.

In some implementations, the conditions may indicate a PLMN list and process 400 may involve communication apparatus 310 suspending the recovery procedure associated with the second SIM for the PLMN list. in an event that a condition indicates that a PLMN is in a specific PLMN list, process 400 may involve communication apparatus 310 skipping and not performing the recovery procedure associated with the second SIM for the PLMN to avoid interrupting the data transmission of the first SIM.

In some implementations, the condition may indicate whether the second SIM can perform data transmission via another SIM and process 400 may involve communication apparatus 310 suspending the recovery procedure associated with the second SIM in an event that the second SIM can perform data transmission via another SIM.

In some implementations, the condition may indicate whether the second SIM can perform data transmission via another service network and process 400 may involve communication apparatus 310 suspending the recovery procedure associated with the second SIM in an event that the second SIM can perform data transmission via another service network.

In some implementations, the condition may indicate a state of the first SIM and process 400 may involve communication apparatus 310 suspending the recovery procedure associated with the second SIM when the state of the first SIM 1 enters a connected mode.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method for improving throughput of a communication apparatus configured with a first subscriber identity module (SIM) and a second SIM, comprising:
performing, by a processor of the communication apparatus, data transmission associated with the first SIM;
determining, by the processor, whether to suspend a recovery procedure associated with the second SIM according to a condition; and
suspending, by the processor, the recovery procedure associated with the second SIM in an event that the condition is satisfied.

2. The method of claim 1, further comprising:
resuming, by the processor, the recovery procedure associated with the second SIM when the first SIM enters an idle mode.

3. The method of claim 1, further comprising:
resuming, by the processor, the recovery procedure associated with the second SIM when the data transmission associated with first SIM is stopped.

4. The method of claim 1, wherein the condition comprises a user preference, and wherein the suspending comprises suspending the recovery procedure associated with the second SIM according to the user preference.

5. The method of claim 1, wherein the condition indicates a non-supported radio access technology (RAT), and wherein the suspending comprises suspending the recovery procedure associated with the second SIM for the non-supported RAT.

6. The method of claim 1, wherein the condition indicates a public land mobile network (PLMN) list, and wherein the suspending comprises suspending the recovery procedure associated with the second SIM for the PLMN list.

7. The method of claim 1, wherein the condition indicates whether the second SIM can perform data transmission via another SIM, and wherein the suspending comprises suspending the recovery procedure associated with the second SIM in an event that the second SIM can perform data transmission via the another SIM.

8. The method of claim 1, wherein the condition indicates whether the second SIM can perform data transmission via another service network, and wherein the suspending comprises suspending the recovery procedure associated with the second SIM in an event that the second SIM can perform data transmission via the another service network.

9. The method of claim 1, wherein the second SIM is in a state of limited service or no service.

10. The method of claim 1, wherein the condition indicates a state of the first SIM, and wherein the suspending comprises suspending the recovery procedure associated with the second SIM when the state of the first SIM enters a connected mode.

11. A communication apparatus, comprising:
a first subscriber identity module (SIM);
a second SIM;
a transceiver capable of performing data transmission associated with the first SIM and the second SIM; and
a processor communicatively coupled to the transceiver, the processor capable of:
determining whether to suspend a recovery procedure associated with the second SIM according to a condition when the transceiver is performing data transmission associated with the first SIM; and
suspending the recovery procedure associated with the second SIM in an event that the condition is satisfied.

12. The communication apparatus of claim 11, wherein the processor is further capable of:
resuming the recovery procedure associated with the second SIM when the first SIM enters an idle mode.

13. The communication apparatus of claim 11, wherein the processor is further capable of:
resuming the recovery procedure associated with the second SIM when the data transmission associated with first SIM is stopped.

14. The communication apparatus of claim 11, wherein the condition comprises a user preference, and wherein, in suspending the recovery procedure, the processor suspends the recovery procedure associated with the second SIM according to the user preference.

15. The communication apparatus of claim 11, wherein the condition indicates a non-supported radio access technology (RAT), and wherein, in suspending the recovery procedure, the processor suspends the recovery procedure associated with the second SIM for the non-supported RAT.

16. The communication apparatus of claim 11, wherein the condition indicates a public land mobile network (PLMN) list, and wherein, in suspending the recovery procedure, the processor suspends the recovery procedure associated with the second SIM for the PLMN list.

17. The communication apparatus of claim 11, wherein the condition indicates whether the second SIM can perform data transmission via another SIM, and wherein, in suspending the recovery procedure, the processor suspends the recovery procedure associated with the second SIM in an event that the second SIM can perform data transmission via the another SIM.

18. The communication apparatus of claim 11, wherein the condition indicates whether the second SIM can perform data transmission via another service network, and wherein, in suspending the recovery procedure, the processor suspends the recovery procedure associated with the second SIM in an event that the second SIM can perform data transmission via the another service network.

19. The communication apparatus of claim 11, wherein the second SIM is in a state of limited service or no service.

20. The communication apparatus of claim 11, wherein the condition indicates a state of the first SIM, and wherein, in suspending the recovery procedure, the processor suspends the recovery procedure associated with the second SIM when the state of the first SIM enters a connected mode.
